(19) United States
(12) Patent Application Publication
(10) Pub. No.: US 2026/0181270 A1
(43) Pub. Date: Jun. 25, 2026

(54) IMAGE PROCESSING DEVICE AND IMAGE PROCESSING METHOD

(71) Applicant: CANON KABUSHIKI KAISHA, Tokyo (JP)

(72) Inventor: TSUKASA MATSUI, Kanagawa (JP)

(21) Appl. No.: 19/427,523

(22) Filed: Dec. 19, 2025

(30) Foreign Application Priority Data
Dec. 25, 2024 (JP) 2024-228887

(51) Int. Cl. H04N 23/951; G06T 3/40; G06T 7/521; G06T 7/55; H04N 23/90

(52) U.S. Cl. CPC H04N 23/951; G06T 3/40; G06T 7/521; G06T 7/55; H04N 23/90; G06T 2207/10028; G06T 2207/10068; G06T 2207/20212; G06T 2207/30252

(57) ABSTRACT

An image processing device includes a pair of first imaging units, each configured to output a first image, a second imaging unit configured to have a wider angle of view than an angle of view of the first imaging unit and output a second image having a resolution lower than a resolution of the first image, a ranging unit configured to acquire a distance information based on a distance to a subject and a combining unit configured to generate a pair of composite images by combining each of the pair of first images with the second image based on the distance information.

### BACKGROUND

### Field of the Technology

The present disclosure relates to an image processing device, and an image processing method.

### Description of the Related Art

In a head mounted display, a technique of capturing an image of a region of interest and an image of a peripheral region using different cameras is known. In the techniques described in Japanese Patent Laid-Open No. 2022-527708, Japanese Patent Laid-Open No. 2017-204674, and Japanese Patent Laid-Open No. 2023-14082, an image of a region of interest acquired by a high-resolution camera and an image of a peripheral region acquired by a low-resolution camera are combined and displayed.

However, in the techniques described in Japanese Patent Laid-Open No. 2022-527708, Japanese Patent Laid-Open No. 2017-204674, and Japanese Patent Laid-Open No. 2023-14082, a positional shift occurs between the image of the region of interest and the image of the peripheral region, and the image quality of a composite image may be degraded.

### SUMMARY

Embodiments of the present disclosure are directed to an image processing device capable of generating a good composite image.

According to embodiments of the present disclosure, there is provided an image processing device including a pair of first imaging units, each configured to output a first image, a second imaging unit configured to have a wider angle of view than an angle of view of the first imaging unit and output a second image having a resolution lower than a resolution of the first image, a ranging unit configured to acquire a distance information based on a distance to a subject and a combining unit configured to generate a pair of composite images by combining each of the pair of first images with the second image based on the distance information.

According to embodiments of the present disclosure, there is provided an image processing method including outputting a pair of first images, outputting a second image having a wider angle of view than an angle of view of the pair of first images and a resolution lower than a resolution of the pair of first images, acquiring a distance information based on a distance to a subject and generating a pair of composite images by combining each of the pair of first images with the second image based on the distance information.

According to embodiments of the present disclosure, there is provided a non-transitory computer-readable storage medium storing a program for causing a computer to execute a method including outputting a pair of first images, outputting a second image having a wider angle of view than an angle of view of the pair of first images and a resolution lower than a resolution of the pair of first images, acquiring a distance information based on a distance to a subject and generating a pair of composite images by combining each of the pair of first images with the second image based on the distance information.

Features of the present disclosure will become apparent from the following description of embodiments with reference to the attached drawings. The following description of embodiments is described by way of example.

### BRIEF DESCRIPTION OF THE DRAWINGS

FIG. 1A and FIG. 1B are external views of an image processing device according to a first embodiment.

FIG. 2 is a block diagram of the image processing device according to the first embodiment.

FIG. 3 is a diagram illustrating an imaging range of an imaging unit according to the first embodiment.

FIG. 4 is a diagram illustrating an example of image processing of an image processing unit according to the first embodiment.

FIG. 5 is a diagram illustrating an example of image processing performed by a combining unit according to the first embodiment.

FIG. 6 is an example of a composite image in the image processing device according to the first embodiment.

FIG. 7 is an example of a composite image in an image processing device according to a Comparative Example.

FIG. 8 is a flowchart illustrating an image processing method in the image processing device according to the first embodiment.

FIG. 9 is a block diagram of an image processing device according to a second embodiment.

FIG. 10 is a diagram illustrating an imaging range of the imaging unit according to the second embodiment.

FIG. 11 is a diagram illustrating an example of image processing of the image processing unit according to the second embodiment.

FIG. 12 is a flowchart illustrating an image processing method in the image processing device according to the second embodiment.

FIG. 13 is a block diagram of an image processing device according to a third embodiment.

FIG. 14 is a diagram illustrating a ranging range of a ranging device according to the third embodiment.

FIG. 15 is a flowchart illustrating an image processing method in the image processing device according to the third embodiment.

FIG. 16 is a block diagram of an image processing device according to a fourth embodiment.

FIG. 17 is a diagram illustrating an application example of an image processing device according to a fifth embodiment to a vehicle.

FIG. 18 is a block diagram of an endoscopic surgery system according to a sixth embodiment.

### DESCRIPTION OF THE EMBODIMENTS

### First Embodiment

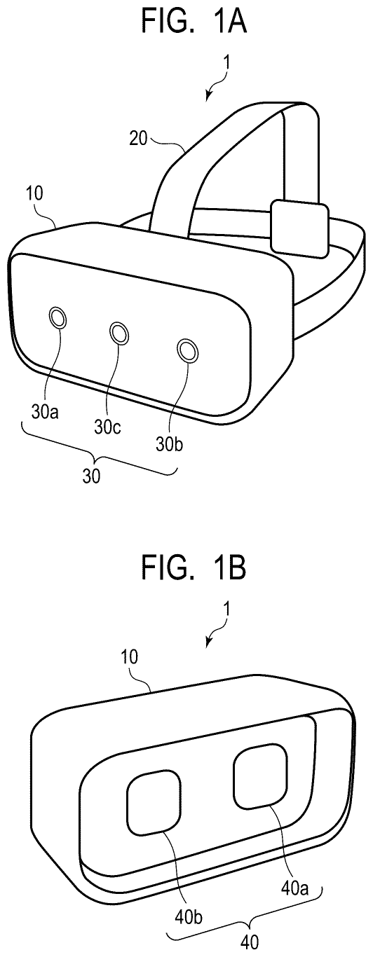

FIG. 1A and FIG. 1B are external views of an image processing device 1 according to the present embodiment. FIG. 1A is a front perspective view of the image processing device 1, and FIG. 1B is a rear perspective view of the image processing device 1. In FIG. 1A and FIG. 1B, a head mounted display is illustrated as an example of the image processing device 1 according to the present embodiment, but it is not limited thereto.

The image processing device 1 includes a main body unit 10, a mounting unit 20, an imaging unit 30, and a display unit 40. The main body unit 10 has a shape that covers the left and right eyes of the user when the image processing device 1 is worn on the head of the user.

The mounting unit 20 is provided on a side surface of the main body unit 10. The mounting unit 20 is made of an elastic material such as rubber, and may include a mounting band that fixes the main body unit 10 to the head of the user. The mounting unit 20 may be configured to be expandable and contractible by an operation of the user.

The imaging unit 30 is provided on the front surface of the main body unit 10. The imaging unit 30 captures an image of an external world (real space) corresponding to a direction of the face of the user. The imaging unit 30 includes a right imaging unit 30a, a left imaging unit 30b, and a center imaging unit 30c. The right imaging unit 30a and the left imaging unit 30b (a pair of first imaging units) are provided apart from each other by a predetermined distance. The predetermined distance may be an interpupillary distance (IPD). The right imaging unit 30a captures an image of an area (a region of interest) near a gaze point in the right eye of the user. The left imaging unit 30b captures an image of a region of interest in the left eye of the user. The center imaging unit 30c (second imaging unit) is provided between the right imaging unit 30a and the left imaging unit 30b. The center imaging unit 30c captures a region (peripheral region) including the region of interest of the right eye and the region of interest of the left eye. The optical systems of the right imaging unit 30a, the left imaging unit 30b, and the center imaging unit 30c may be arranged on the same straight line. In addition, the optical axes of the right imaging unit 30a, the left imaging unit 30b, and the center imaging unit 30c may be provided oriented in the same direction.

The display unit 40 is provided on a rear surface of the main body unit 10. The display unit 40 displays an image of the external world captured by the imaging unit 30. The display unit 40 may display a composite image of an image of the external world and a virtual object. Thus, mixed reality (MR) can be realized.

The display unit 40 includes a right display unit 40a and a left display unit 40b. The right display unit 40a is provided at a position corresponding to the right eye of the user wearing the image processing device 1 and displays an image for the right eye. The left display unit 40b is provided at a position corresponding to the left eye of the user wearing the image processing device 1 and displays an image for the left eye.

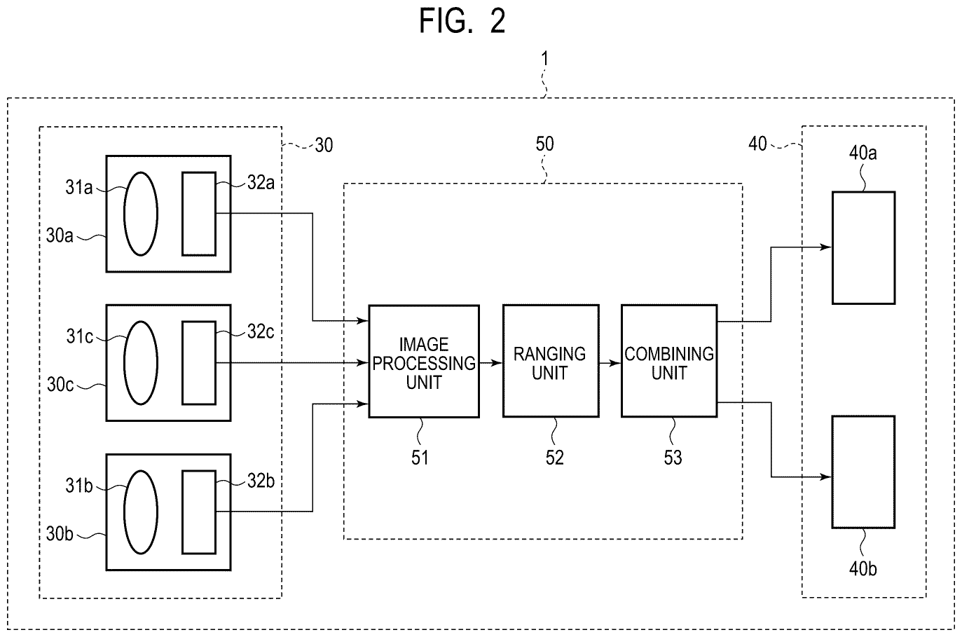

FIG. 2 is a block diagram of the image processing device 1 according to the present embodiment. The image processing device 1 includes the imaging unit 30, the display unit 40, and a control unit 50. The imaging unit 30 includes the right imaging unit 30a, the left imaging unit 30b, and the center imaging unit 30c. The display unit 40 includes the right display unit 40a and the left display unit 40b. The control unit 50 includes an image processing unit 51, a ranging unit 52, and a combining unit 53.

The right imaging unit 30a includes a lens 31a and an imaging element 32a. The lens 31a forms an optical image of a subject on an imaging surface of the imaging element 32a. The imaging element 32a may be configured by a complementary metal oxide semiconductor (CMOS) image sensor, a charge coupled device (CCD) image sensor, or the like. The imaging element 32a may be configured by a single photon avalanche diode (SPAD) image sensor or the like. The imaging element 32a converts the optical image of the subject formed by the lens 31a into an electrical signal by photoelectric conversion, and outputs the electrical signal as image data to the image processing unit 51. Each pixel included in the imaging element 32a includes a filter of a predetermined wavelength. The filter of the wavelength may be, for example, a primary color filter of red, blue, and green, and may be provided in each pixel of the imaging element 32a according to the Bayer array.

The left imaging unit 30b includes a lens 31b and an imaging element 32b. The left imaging unit 30b may be configured in the same manner as the right imaging unit 30a. The imaging element 32b converts the optical image of the subject formed by the lens 31b into an electrical signal by photoelectric conversion, and outputs the electrical signal as image data to the image processing unit 51.

The center imaging unit 30c includes a lens 31c and an imaging element 32c. Lens 31c may have a shorter focal length than lens 31a and lens 31b. Therefore, the lens 31c forms an optical image having an optical size larger than those of the lens 31a and the lens 31b on the imaging surface of the imaging element 32c. The imaging element 32c converts the optical image of the subject formed by the lens 31c into an electrical signal by photoelectric conversion, and outputs the electrical signal as image data to the image processing unit 51.

The imaging element 32c is configured to be able to measure the distance between the center imaging unit 30c and the subject. For example, the imaging element 32c may include pixels capable of detecting the image plane phase difference. Accordingly, the imaging element 32c can have a ranging function.

The number of pixels per angle of view of the center imaging unit 30c is smaller than the number of pixels per angle of view of the right imaging unit 30a and the left imaging unit 30b. For example, when the angle of view of the right imaging unit 30a is 60 degrees and the number of pixels is 1200, the number of pixels per angle of view of the right imaging unit 30a is 20 pixels/degree. Similarly, when the angle of view of the left imaging unit 30b is 60 degrees and the number of pixels is 1200, the number of pixels per angle of view of the left imaging unit 30b is 20 pixels/degree. At this time, the number of pixels per angle of view of the center imaging unit 30c is less than 20 pixels/degrees. For example, the angle of view per angle of view of the center imaging unit 30c may be 120 degrees, the number of pixels may be 1200, and the number of pixels per angle of view of the center imaging unit 30c may be 10 pixels/degree. Here, the larger the number of pixels per angle of view, the higher the resolution of the captured image. Therefore, the resolution of the captured image in the right imaging unit 30a and the left imaging unit 30b is higher than the resolution of the captured image in the center imaging unit 30c.

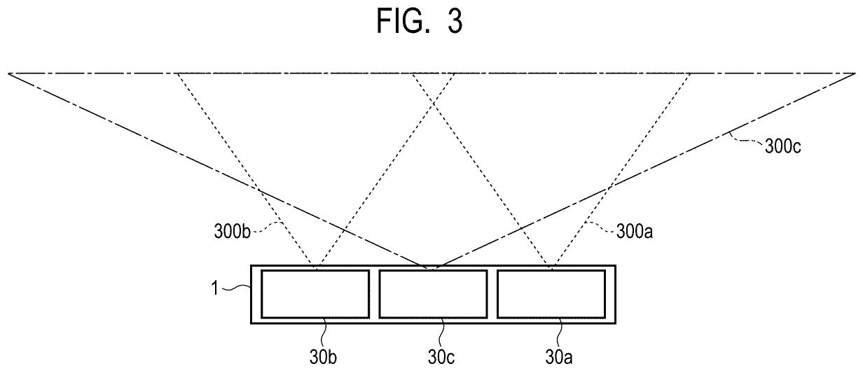

FIG. 3 is a diagram illustrating an imaging range of the imaging unit 30 according to the first embodiment. FIG. 3 schematically illustrates imaging ranges of the right imaging unit 30a, the left imaging unit 30b, and the center imaging unit 30c. The right imaging range 300a is an imaging range of the right imaging unit 30a and includes a region of interest of the right eye. The left imaging range 300b is an imaging range of the left imaging unit 30b and includes a region of interest of the left eye. The center imaging range 300c is an imaging range of the center imaging unit 30c and includes a peripheral region.

The angle of view of the center imaging unit 30c is wider than the angle of view of the right imaging unit 30a and the angle of view of the left imaging unit 30b. Accordingly, the center imaging unit 30c can capture the peripheral region including the region of interest of the right eye and the region of interest of the left eye. The angle of view of each of the right imaging unit 30a, the left imaging unit 30b, and the center imaging unit 30c may be variable. In this case, the angle of view of the center imaging unit 30c may be set wider than those of the right imaging unit 30a and the left imaging unit 30b.

The control unit 50 may be configured by hardware similar to that of a general information processing device. For example, the control unit 50 may include a center processing unit (CPU), a main storage unit, a communication unit, an input/output interface, or the like. Each functional block included in the control unit 50 may be configured by hardware such as a large scale integrated (LSI) incorporating a program. Further, the functions of the control unit 50 can be realized by software by loading a program into the main storage unit and executing the program by the CPU. The configuration of the control unit 50 is not particularly limited as long as the functions described in the present embodiment can be realized.

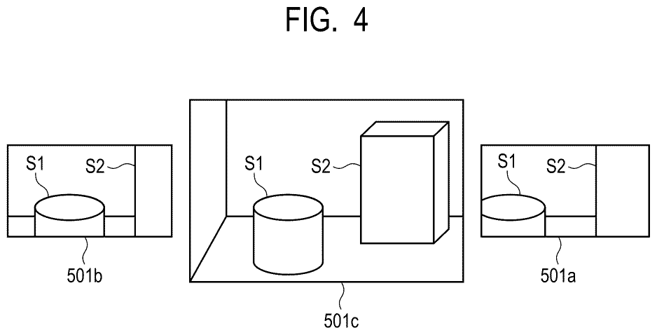

The image processing unit 51 performs development processing on the image data and generates a captured image from the image data. The development processing may include crop processing for cutting out an effective range of image data, correction processing for distortion due to a lens, correction processing for brightness, demosaic processing, or the like. The image processing unit 51 transforms the captured image so that the shapes and sizes of the subjects in the captured images of the right imaging unit 30a, the left imaging unit 30b, and the center imaging unit 30c are the same. FIG. 4 is a diagram illustrating an example of image processing of the image processing unit 51 according to the present embodiment. FIG. 4 illustrates captured images of a cylindrical subject S1 and a rectangular parallelepiped subject S2. FIG. 4 illustrates a right image 501a, a left image 501b, and a center image 501c. The right image 501a represents a region of interest of the right eye of the user. The right image 501a is acquired by performing development processing on the image data of the right imaging unit 30a. The left image 501b represents a region of interest of the left eye of the user. The left image 501b is acquired by performing development processing on the image data of the left imaging unit 30b. The center image 501c represents a peripheral region of the left and right eyes of the user. The center image 501c is acquired by performing development processing on the image data of the center imaging unit 30c. The image processing unit 51 enlarges or reduces the captured images of the right imaging unit 30a, the left imaging unit 30b, and the center imaging unit 30c so that the shapes and sizes of the subject S1 and the subject S2 are the same, and generates the right image 501a, the left image 501b, and the center image 501c.

The ranging unit 52 calculates distances from the right imaging unit 30a, the left imaging unit 30b, and the center imaging unit 30c to the subject based on the image data, and acquires the distances as distance information. For example, the ranging unit 52 calculates the distance to the subject from the image plane phase difference detected by the pixels of the imaging element 32c. The ranging unit 52 may perform correction processing such as smoothing, opening, and closing on the image data based on the calculated distance.

The combining unit 53 sets camera coordinates Mw(Xw, Yw, Zw) in the world coordinate system based on the distance information with the center imaging unit 30c as a reference point. Here, the Z axis is a depth direction from the imaging unit 30 to the subject, and the X axis and the Y axis are two different directions orthogonal to the Z axis. The combining unit 53 converts the camera coordinates Mw(Xw, Yw, Zw) of the center imaging unit 30c into the camera coordinate system Mc(Xc, Yc, Zc) of the right imaging unit 30a. The coordinate transformation between the camera coordinates Mw(Xw, Yw, Zw) and the camera coordinate system Mc(Xc, Yc, Zc) is expressed by the following expression.

$$M c = [ R ] [ t ] Mw \qquad ( 1 )$$

In Expression (1), [R] [t] is an external parameter corresponding to the camera coordinate system Mc. Here, the optical systems of the right imaging unit 30a, the left imaging unit 30b, and the center imaging unit 30c may be provided on the same straight line, and the optical axes of the right imaging unit 30a, the left imaging unit 30b, and the center imaging unit 30c may be oriented in the same direction. As a result, the X coordinate Xw is equal to the X coordinate Xc or the Y coordinate Yw is equal to the Y coordinate Yc. Therefore, the coordinate conversion of the X coordinate or the Y coordinate in the above Expression (1) becomes unnecessary, and the processing load in the coordinate conversion can be reduced.

The combining unit 53 converts the camera coordinate system Mc into image coordinates x (xi, yi) by perspective projection conversion. The coordinate conversion between the camera coordinate system Mc and the image coordinates x is expressed by the following expression.

$$sx = AMc \qquad ( 2 )$$

In Expression (2), s is a constant, and A is an internal parameter of the right imaging unit 30a. The internal parameter A may be, for example, a focal length. In this way, the combining unit 53 generates a converted image obtained by performing coordinate conversion centering on the right imaging unit 30a, using the image of the center imaging unit 30c. Similarly, the combining unit 53 generates a coordinate-converted image obtained by performing coordinate conversion centering on the left imaging unit 30b using the captured image of the peripheral region of the center imaging unit 30c.

The following expression is satisfied between the camera coordinate system Mc and the image coordinates x.

$$x i = f \frac{X c}{Z c} , y i = f \frac{Y c}{Z c} \qquad ( 3 )$$

In Expression (3), f is the focal length of the right imaging unit 30a. As shown in Expression (3), the image is moved so that the x coordinate and the y coordinate become f/Zc times by the coordinate conversion. The combining unit 53 moves the image of the center imaging unit 30c in accordance with the image of the right imaging unit 30a to generate a right converted image. Similarly, the combining unit 53 moves the image of the center imaging unit 30c in accordance with the image of the left imaging unit 30b to generate a left converted image.

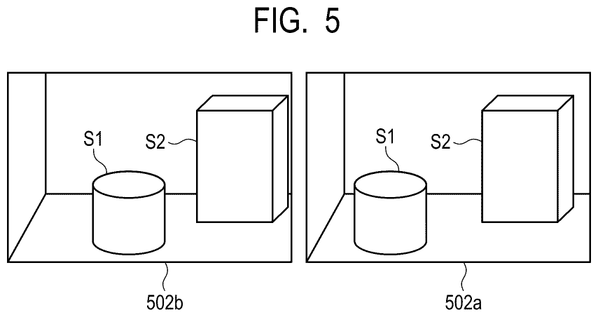

FIG. 5 is a diagram illustrating an example of image processing performed by the combining unit 53 according to the present embodiment. The right converted image 502a is generated by coordinate-converting the center image 501c in accordance with the right image 501a. The left converted image 502b is generated by coordinate-converting the center image 501c in accordance with the left image 501b. The subject S1 and the subject S2 are moved by the coordinate conversion. Since the subject S1 is disposed closer to the image processing device 1 than the subject S2, the amount of movement of the subject S1 in the coordinate conversion of the combining unit 53 is larger than the amount of movement of the subject S2.

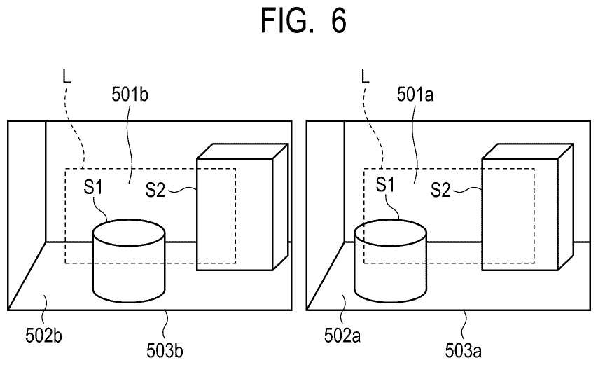

The combining unit 53 combines the image of the peripheral region after the coordinate conversion with the image of the region of interest to generate a composite image. The combining unit 53 outputs a pair of composite images to the right display unit 40a and the left display unit 40b. FIG. 6 is an example of a composite image in the image processing device 1 according to the present embodiment. In FIG. 6, a boundary L indicated by a dotted line represents a boundary L of composition of the image of the region of interest and the image of the peripheral region. A right composite image 503a is a composite image of the right image 501a and the right converted image 502a. In the right composite image 503a, the inside of the boundary L corresponds to the right image 501a, and the outside of the boundary L corresponds to the right converted image 502a. Since the image composition is performed using the right converted image 502a on which the coordinate conversion is performed, a positional shift at the boundary L due to a parallax between the right imaging unit 30a and the center imaging unit 30c is suppressed. Thus, a good composite image can be generated. A left composite image 503b is a composite image of the left image 501b and the left converted image 502b. In the left composite image 503b, the inside of the boundary L corresponds to the left image 501b, and the outside of the boundary L corresponds to the left converted image 502b. Since the image composition is performed using the left converted image 502b on which the coordinate conversion is performed, a positional shift at the boundary L due to a parallax between the left imaging unit 30b and the center imaging unit 30c is suppressed. Thus, a good composite image can be generated.

Note that the combining unit 53 may perform processing such as alpha blending, multiband blending, Poisson blending, and stitching.

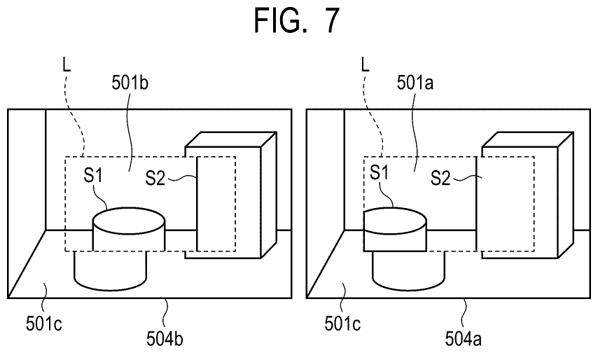

FIG. 7 is an example of a composite image in an image processing device according to a Comparative Example. In the image processing device according to the Comparative Example, the coordinate conversion of the image of the peripheral region is not performed. In FIG. 7, a boundary L represents a boundary of composition of the image of the region of interest and the image of the peripheral region. A right composite image 504a is a composite image of the right image 501a and the center image 501c. In the right composite image 504a, the inside of the boundary L corresponds to the right image 501a, and the outside of the boundary L corresponds to the center image 501c. A left composite image 504b is a composite image of the left image 501b and the center image 501c. In the left composite image 504b, the inside of the boundary L corresponds to the left image 501b, and the outside of the boundary L corresponds to the center image 501c. The composite image according to the Comparative Example gives the user an unnatural impression due to positional shift at the boundary L.

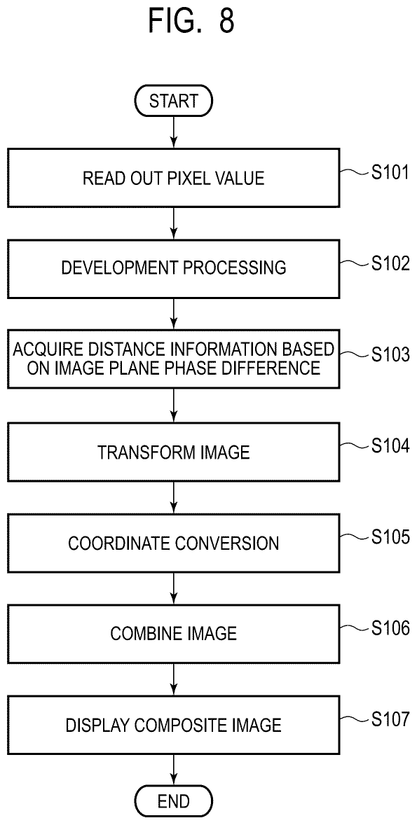

FIG. 8 is a flowchart illustrating an image processing method in the image processing device 1 according to the present embodiment. The image processing unit 51 reads out pixel values corresponding to the pixel data output from each of the right imaging unit 30a, the left imaging unit 30b, and the center imaging unit 30c (step S101). The image processing unit 51 performs development processing on the read pixel values to generate captured images of the right imaging unit 30a, the left imaging unit 30b, and the center imaging unit 30c (step S102).

The ranging unit 52 calculates a distance from the center imaging unit 30c to the subject and acquires the distance as distance information (step S103). For example, the ranging unit 52 calculates the distance from the center imaging unit 30c to the subject based on the image plane phase difference detected by the pixels of the center imaging unit 30c.

The image processing unit 51 transforms the captured image so that the sizes of the subjects in the captured images of the right imaging unit 30a, the left imaging unit 30b, and the center imaging unit 30c are the same (step S104). Thus, the image processing unit 51 generates the right image 501a, the left image 501b, and the center image 501c.

The combining unit 53 performs coordinate conversion on the center image 501c in accordance with the above-described Expressions (1) to (3) (step S105). The combining unit 53 converts the camera coordinates Mw of the center imaging unit 30c into the camera coordinate system Mc of the right imaging unit 30a. That is, the combining unit 53 moves the subject S1 and the subject S2 in the center image 501c in accordance with the right image 501a to generate the right converted image 502a. In addition, the combining unit 53 converts the camera coordinates Mw of the center imaging unit 30c into the camera coordinate system Mc of the left imaging unit 30b. That is, the combining unit 53 moves the subject S1 and the subject S2 in the center image 501c in accordance with the left image 501b to generate the left converted image 502b.

The combining unit 53 combines the image of the peripheral region after the coordinate conversion with the image of the region of interest (step S106). The combining unit 53 combines the right converted image 502a with the center image 501c to generate the right composite image 503a. In addition, the combining unit 53 combines the left converted image 502b with the center image 501c to generate the left composite image 503b. The right composite image 503a is output to the right display unit 40a, and the left composite image 503b is output to the left display unit 40b.

The right display unit 40a displays the right composite image 503a output from the combining unit 53, and the left display unit 40b displays the left composite image 503b output from the combining unit 53 (step S107).

As described above, in the present embodiment, by performing the image composition based on the distance information, it is possible to suppress the positional shift of the image and to generate a good composite image.

### Second Embodiment

Next, an image processing device according to a second embodiment will be described. The image processing device according to the present embodiment is different from the image processing device according to the first embodiment in that distance information is acquired from two center imaging units. Hereinafter, a configuration different from that of the first embodiment will be mainly described.

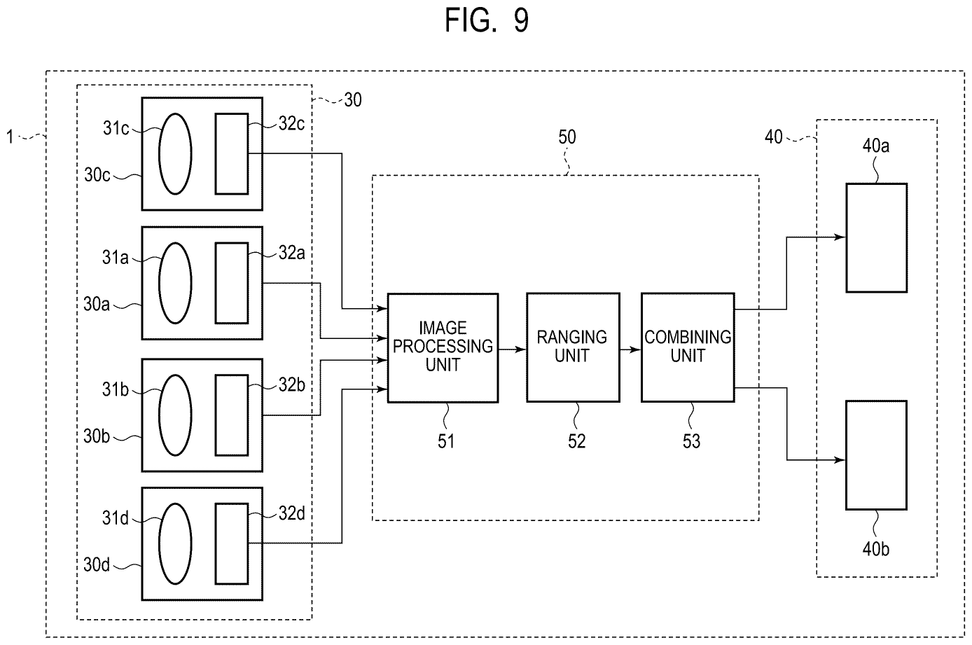

FIG. 9 is a block diagram of the image processing device 1 according to the present embodiment. The imaging unit 30 further includes a center imaging unit 30d. In the present embodiment, the captured image of the center imaging unit 30c and the captured image of the center imaging unit 30d are used to calculate the distance to the subject. The center imaging unit 30d includes a lens 31d and an imaging element 32d. The center imaging unit 30d may be configured in the same manner as the center imaging unit 30c. The imaging element 32d converts the optical image of the subject formed by the lens 31d into an electrical signal by photoelectric conversion, and outputs the electrical signal as image data to the image processing unit 51.

The number of pixels per angle of view of the center imaging unit 30d is smaller than the number of pixels per angle of view of the right imaging unit 30a and the left imaging unit 30b. Therefore, the resolution of the captured image in the center imaging unit 30d is lower than the resolutions of the captured images in the right imaging unit 30a and the left imaging unit 30b.

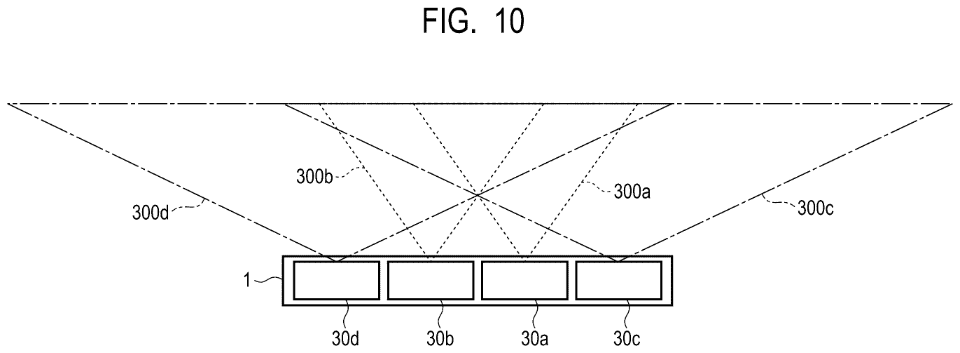

FIG. 10 is a diagram illustrating an imaging range of the imaging unit 30 according to the second embodiment. FIG. 10 schematically illustrates imaging ranges of the right imaging unit 30a, the left imaging unit 30b, the center imaging unit 30c, and the center imaging unit 30d when the image processing device 1 is viewed from above. In FIG. 10, the right imaging unit 30a and the left imaging unit 30b are provided between the center imaging unit 30c and the center imaging unit 30d, but are not limited thereto. For example, the center imaging unit 30c and the center imaging unit 30d may be provided between the right imaging unit 30a and the left imaging unit 30b. A center imaging range 300d is a range in which an image is captured by the center imaging unit 30d, and includes a peripheral region. The optical systems of the right imaging unit 30a, the left imaging unit 30b, the center imaging unit 30c, and the center imaging unit 30d may be provided on the same straight line. In addition, the optical axes of the right imaging unit 30a, the left imaging unit 30b, the center imaging unit 30c, and the center imaging unit 30d may be oriented in the same direction. As a result, the coordinate conversion of the X coordinate or the Y coordinate in the above Expression (1) becomes unnecessary, and the processing load in the coordinate conversion can be reduced.

The angle of view of the center imaging unit 30d is wider than the angle of view of the right imaging unit 30a and the angle of view of the left imaging unit 30b. Accordingly, the center imaging unit 30d can capture the peripheral region including the region of interest of the right eye and the region of interest of the left eye. The angle of view of the center imaging unit 30d may be variable. In this case, the angle of view of the center imaging unit 30d may be set wider than those of the right imaging unit 30a and the left imaging unit 30b.

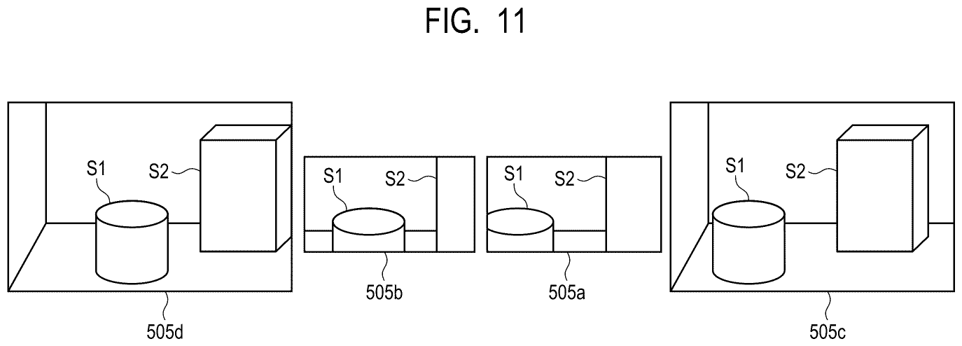

The image processing unit 51 transforms the captured image so that the shapes and sizes of the subjects included in the captured images of the right imaging unit 30a, the left imaging unit 30b, the center imaging unit 30c, and the center imaging unit 30d are the same. FIG. 11 is a diagram illustrating an example of image processing of the image processing unit 51 according to the present embodiment. FIG. 11 illustrates a right image 505a, a left image 505b, a center image 505c, and a center image 505d. The center image 505c and the center image 505d represent peripheral regions of the left and right eyes of the user, and are obtained by performing development processing on the image data of the center imaging unit 30c and the center imaging unit 30d, respectively. The image processing unit 51 enlarges or reduces the images of the right imaging unit 30a, the left imaging unit 30b, the center imaging unit 30c, and the center imaging unit 30d so that the shapes or sizes of the subject S1 and the subject S2 are the same.

The ranging unit 52 calculates the distance to the subject using the principle of triangulation based on the image of the center imaging unit 30c and the image of the center imaging unit 30d.

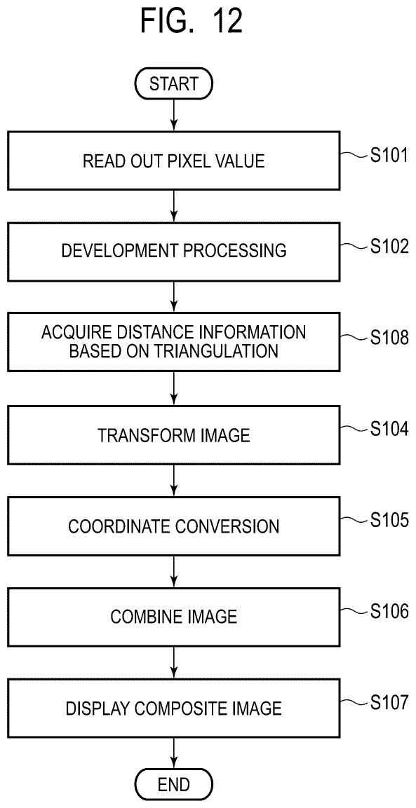

FIG. 12 is a flowchart illustrating an image processing method in the image processing device 1 according to the present embodiment. Steps S101, S102, and S104 to S107 are the same as those in the first embodiment. In the flowchart of FIG. 12, step S108 is performed instead of step S103 of the flowchart of the first embodiment.

The ranging unit 52 calculates the distance to the subject using the images of the center imaging unit 30c and the center imaging unit 30d and acquires the distance as distance information (step S108). The ranging unit 52 calculates the distance to the subject using the principle of triangulation based on the image of the center imaging unit 30c and the image of the center imaging unit 30d.

Also in the present embodiment, by performing image composition based on the distance information, a good composite image can be generated. In particular, in the present embodiment, distance information based on a distance to a subject can be acquired without using an imaging unit capable of detecting an image plane phase difference.

### Third Embodiment

Next, an image processing device according to a third embodiment will be described. The image processing device according to the present embodiment is different from the image processing device according to the first embodiment in that it further includes a ranging device that measures a distance to a subject. Hereinafter, a configuration different from that of the first embodiment will be mainly described.

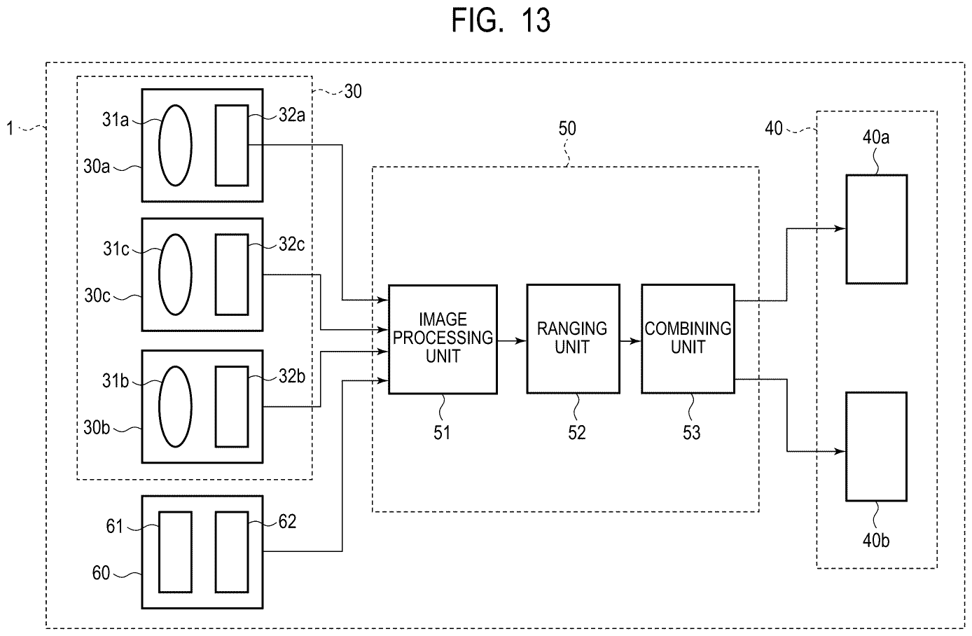

FIG. 13 is a block diagram of the image processing device 1 according to the present embodiment. The image processing device 1 further includes a ranging device 60. The ranging device 60 is, for example, a LiDAR device. The ranging device 60 can measure a distance to a subject by emitting light in a predetermined range and detecting reflected light from the subject.

The ranging device 60 includes a light emitting unit 61 and a light receiving unit 62. The light emitting unit 61 may be a light emitting diode (LED), a laser diode (LD), or a vertical cavity surface emitting laser (VCSEL). The light emitting unit 61 may be a surface light emitting element in which a plurality of VCSELs are arranged in an array. The light emitting unit 61 emits pulsed light such as laser light toward a subject.

The light receiving unit 62 includes a plurality of pixels arranged in a matrix. The light receiving unit 62 receives reflected light from a subject and measures a distance to the subject. The light receiving unit 62 may be, for example, a complementary metal-oxide-semiconductor (CMOS) sensor. The light receiving unit 62 may be a single photon avalanche diode (SPAD) sensor. The light receiving unit 62 converts the optical signal of the reflected light into an electrical signal and outputs the electrical signal to the image processing unit 51.

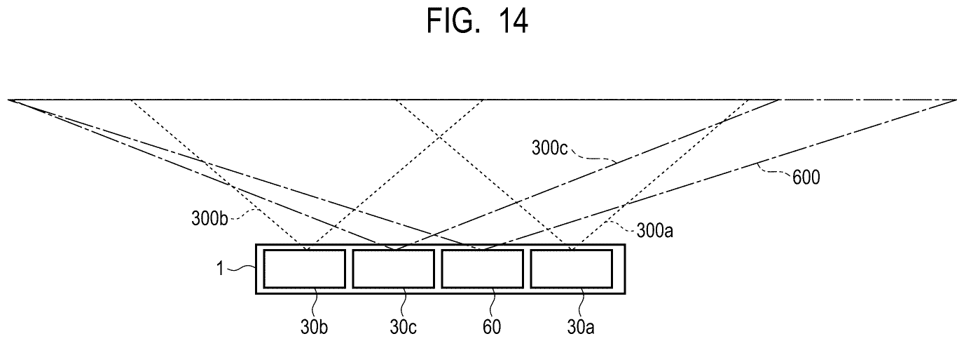

FIG. 14 is a diagram illustrating a ranging range of the ranging device 60 according to the third embodiment. FIG. 14 schematically illustrates imaging ranges of the right imaging unit 30a, the left imaging unit 30b, and the center imaging unit 30c, and a ranging range 600 of the ranging device 60. In FIG. 14, the ranging device 60 is provided between the right imaging unit 30a and the center imaging unit 30c, but is not limited thereto. For example, the ranging device 60 may be provided between the left imaging unit 30b and the center imaging unit 30c.

The ranging range 600 is wider than the center imaging range 300c. Thus, the ranging device 60 can measure the distance to the subject in the peripheral region.

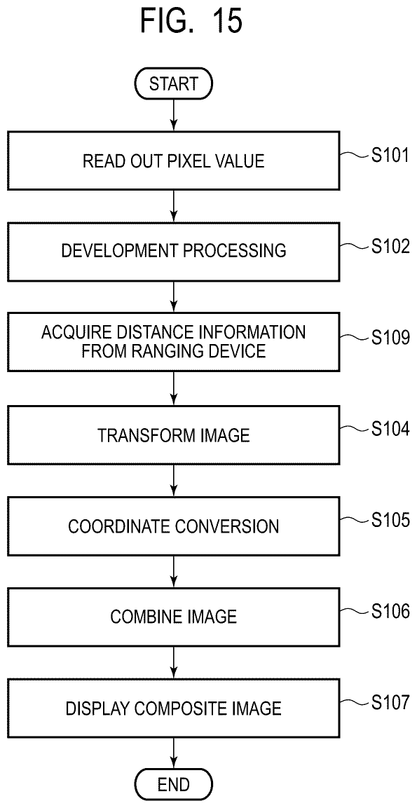

FIG. 15 is a flowchart illustrating an image processing method in the image processing device 1 according to the present embodiment. Steps S101, S102, and S104 to S107 are the same as those in the first embodiment. In the flowchart of FIG. 15, step S109 is performed instead of step S103 of the flowchart of the first embodiment.

The ranging unit 52 calculates the distance to the subject based on the electric signal output from the light receiving unit 62, and acquires the distance as distance information (step S109).

Also in the present embodiment, by performing image composition based on the distance information, a good composite image can be generated. Also in the present embodiment, distance information based on a distance to a subject can be acquired without using an imaging unit capable of detecting an image plane phase difference.

### Fourth Embodiment

Next, an image processing device according to a fourth embodiment will be described. The image processing device according to the present embodiment is different from the image processing device according to the first embodiment in that the display unit 40 is provided separately from the image processing device 1. Hereinafter, a configuration different from that of the first embodiment will be mainly described.

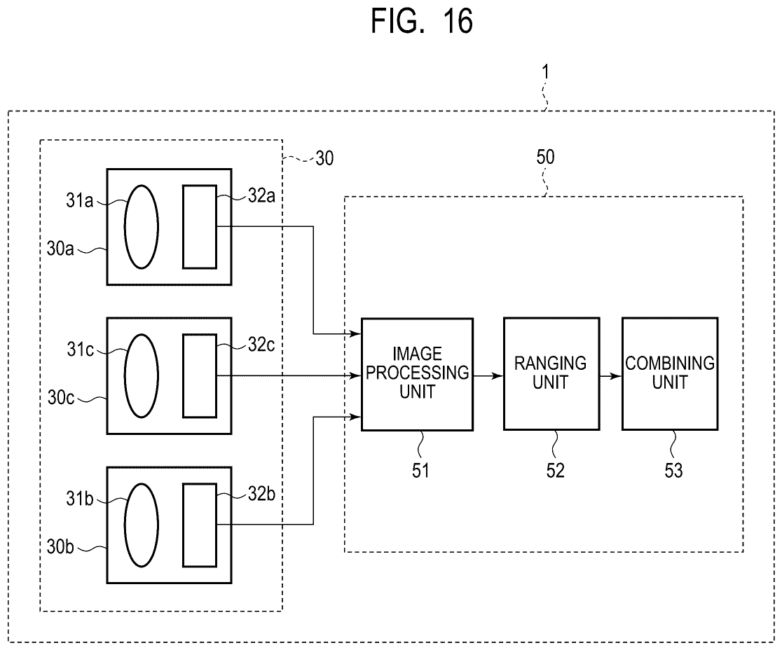

FIG. 16 is a block diagram of the image processing device 1 according to the present embodiment. The display unit 40 provided in the image processing device 1 according to the first embodiment is provided separately from the image processing device 1. The configuration and operation of the image processing unit 51, the ranging unit 52, and the combining unit 53 are the same as those in the first embodiment. The right composite image 503a and the left composite image 503b are output to the display unit 40 provided separately from the image processing device 1. Also in the present embodiment, a good composite image can be generated.

### Fifth Embodiment

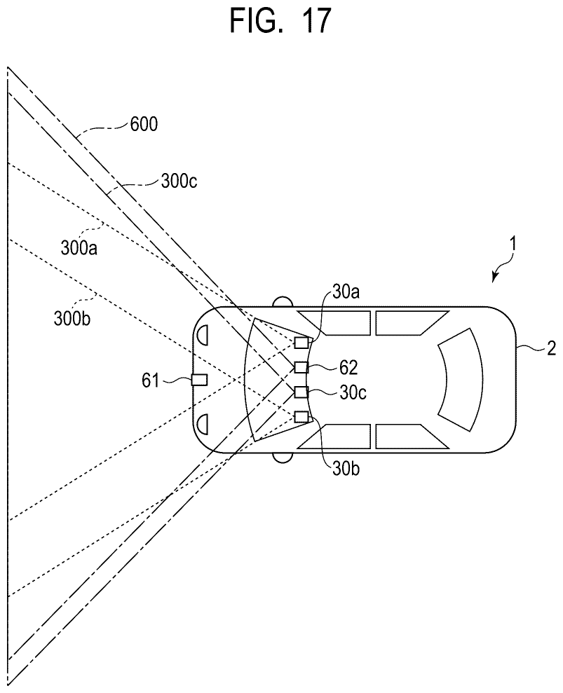

An image processing device and a moving body according to a fifth embodiment of the present disclosure will be described with reference to FIG. 17. FIG. 17 is a diagram illustrating a configuration of an image processing device and a moving body according to the present embodiment. FIG. 17 illustrates an example of an image processing device related to an in-vehicle camera. The image processing device 1 is provided in a vehicle 2. The image processing device 1 is similar to any one of the first to fourth embodiments. The image processing device 1 calculates a parallax (a phase difference between parallax images) from a plurality of pieces of image data, and acquires distance information based on a distance to an object based on the calculated parallax.

The image processing device 1 may be provided in an upper portion of a windshield of the vehicle 2. The right imaging unit 30a, the left imaging unit 30b, the center imaging unit 30c, and the ranging device 60 may be provided in the same manner as in the third embodiment, but are not necessarily provided in such a manner. The right imaging unit 30a, the left imaging unit 30b, the center imaging unit 30c, and the ranging device 60 may be individually configured. Although both the right imaging unit 30a and the left imaging unit 30b are provided in FIG. 17, only one of the right imaging unit 30a and the left imaging unit 30b may be provided. When only one of the right imaging unit 30a and the left imaging unit 30b is provided, one of the right imaging unit 30a and the left imaging unit 30b may be provided between the center imaging unit 30c and the light receiving unit 62. The light emitting unit 61 and the light receiving unit 62 may be provided individually. In FIG. 17, a ranging range 600 is illustrated as a light receiving range of the light receiving unit 62.

Although the control unit 50 is not illustrated in FIG. 17, the control unit 50 is provided at any place where the right imaging unit 30a, the left imaging unit 30b, the center imaging unit 30c, and the ranging device 60 can be controlled. The control unit 50 may determine whether or not there is a collision possibility based on the distance information, and may output a control signal for generating a braking force to the vehicle based on the determination result. The control unit 50 may issue an alarm to the driver based on the determination result of the collision possibility. For example, when the collision possibility is high as the determination result of the control unit 50, the control unit 50 performs vehicle control to avoid collision or reduce damage by braking, returning an accelerator, suppressing engine output, or the like. The control unit 50 alerts the user by sounding an alarm, displaying alert information on a screen of a car navigation system or the like, or giving vibration to a seat belt or a steering wheel.

As described above, according to the image processing device 1 of the present embodiment, since the image composition is performed based on the distance information, it is possible to generate a good composite image.

Although the example of control for avoiding a collision to another vehicle has been described above, the embodiment is applicable to automatic driving control for following another vehicle, automatic driving control for not going out of a traffic lane, or the like. Furthermore, the image processing device 1 is not limited to a vehicle such as an automobile and can be applied to a moving body (moving device) such as a ship, an airplane and an industrial robot, or the like, for example. In addition, the image processing device 1 can be widely applied to equipment which utilizes object recognition, such as an intelligent transportation system (ITS), or the like without being limited to moving bodies.

### Sixth Embodiment

The technique according to the present disclosure can be applied to various products. For example, the technique according to the present disclosure may be applied to an endoscopic surgery system which is one example of an optical detection system. The optical detection system includes the image processing device 1 and a signal processing unit that processes an output signal output from the image processing device 1.

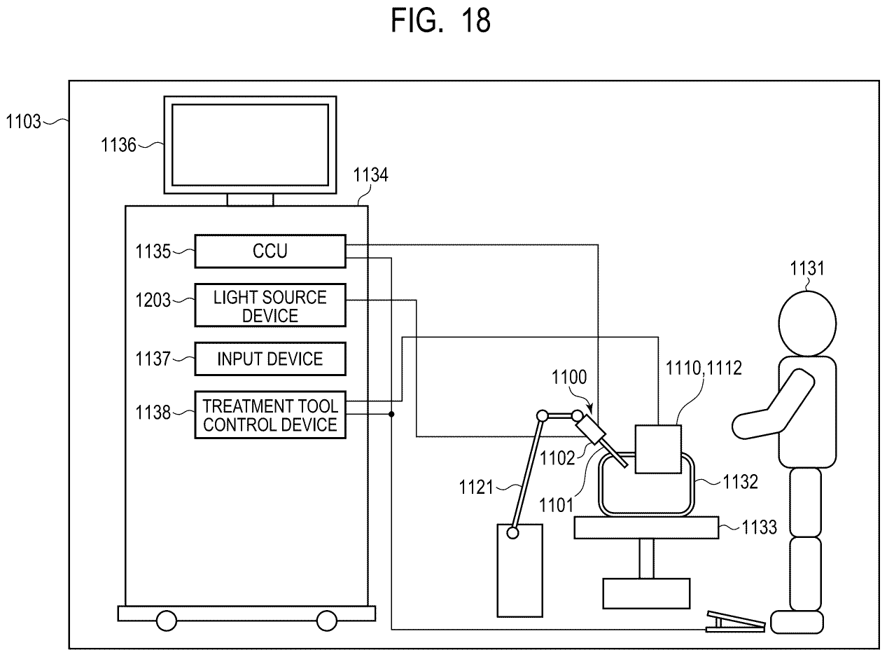

FIG. 18 is a schematic diagram illustrating an endoscopic surgery system according to the present embodiment. FIG. 18 illustrates that an operator (physician) 1131 performs surgery on a patient 1132 on a patient bed 1133 using the endoscopic surgery system 1103. As illustrated, the endoscopic surgery system 1103 of the present embodiment may include an endoscope 1100, a surgical tool 1110 an arm 1121, and a cart 1134 on which various devices for endoscopic surgery are mounted.

The endoscope 1100 includes a lens barrel 1101 in which a region of a predetermined length from the distal end is inserted into the body cavity of the patient 1132, and a camera head 1102 connected to the proximal end of the lens barrel 1101. Although FIG. 18 illustrates the endoscope 1100 configured as a so-called rigid mirror having a rigid lens barrel 1101, the endoscope 1100 may be configured as a so-called flexible mirror having a flexible barrel.

The distal end of the lens barrel 1101 is provided with an opening into which the objective lens is fitted. A light source device 1203 is connected to the endoscope 1100. A light generated by the light source device 1203 is guided to the tip of the lens barrel 1101 by a light guide extended inside the lens barrel 1101, and the light is irradiated toward an observation target in a body cavity of the patient 1132 via an objective lens. Note that the endoscope 1100 may be a direct-viewing mirror, a perspective-viewing mirror, or a side-viewing mirror.

The image processing device described in any of the above first to fourth embodiment is provided inside the camera head 1102, and reflected light (observation light) from an observation target is condensed by the optical system. The image processing device photoelectrically converts the observation light and generates an electrical signal corresponding to the observation light, that is, an image signal corresponding to the observation image. As the image processing device, the image processing device described in any of the first to fourth embodiments can be used. The image signal is transmitted to a camera control unit (CCU) 1135 as RAW data.

The CCU 1135 is configured by a central processing unit (CPU), a graphics processing unit (GPU), or the like, and integrally controls operations of the endoscope 1100 and the display device 1136. Further, the CCU 1135 receives an image signal from the camera head 1102, and performs various types of image processing for displaying an image based on the image signal, such as development processing (demosaic processing). Furthermore, the CCU 1135 implements the functions of the ranging unit 52 and the combining unit 53 described in the above embodiments. The CCU 1135 acquires distance information based on the distance to the observation target, and generates a composite image based on the distance information.

The display device 1136 displays the composite image generated by the CCU 1135 under the control of the CCU 1135.

The light source device 1203 includes, for example, a light source such as a light emitting diode (LED), and supplies irradiation light to the endoscope 1100 when photographing a surgical site or the like.

The input device 1137 is an input interface to the endoscopic surgery system 1103. The user can input various kinds of information and instructions to the endoscopic surgery system 1103 via the input device 1137.

The treatment tool control device 1138 controls the driving of the energy treatment tool 1112 for tissue cauterization, incision, sealing of blood vessels, or the like.

The light source device 1203 that supplies irradiation light when imaging the surgical site to the endoscope 1100 can be configured by, for example, a white light source configured by an LED, a laser light source, or a combination thereof. When the white light source is configured by a combination of the RGB laser light sources, the output intensity and the output timing of each color (each wavelength) can be controlled with high accuracy. Therefore, the white balance of the captured image can be adjusted in the light source device 1203. In addition, in this case, the observation target may be irradiated with laser light from each of RGB laser light sources in a time division manner, and the driving of the imaging element of the camera head 1102 may be controlled in synchronization with the irradiation timing. Thus, it is also possible to capture an image corresponding to each of RGB in a time division manner. According to this method, a color image can be obtained without providing a color filter in the image sensor.

Further, the driving of the light source device 1203 may be controlled so as to change the intensity of light to be output every predetermined time. By controlling the driving of the image sensor of the camera head 1102 in synchronization with the timing of the change of the intensity of the light to acquire an image in a time-division manner and synthesizing the image, it is possible to generate an image having a high dynamic range free from so-called black blur and white blur.

The light source device 1203 may be configured to be capable of supplying light in a predetermined wavelength band corresponding to special light observation. In the special light observation, for example, wavelength dependency of absorption of light in body tissue is utilized. Specifically, a predetermined tissue such as a blood vessel in the superficial layer of a mucous membrane is photographed with high contrast by irradiating light in a narrow band as compared with irradiation light (that is, white light) at the time of normal observation. Alternatively, in the special light observation, fluorescence observation in which an image is obtained by fluorescence generated by irradiation with excitation light may be performed. In the fluorescence observation, a body tissue is irradiated with excitation light to observe fluorescence from the body tissue, or a body tissue is locally injected with reagent such as indocyanine green (ICG), and the body tissue is irradiated with excitation light corresponding to a fluorescence wavelength of the reagent to obtain a fluorescence image. The light source device 1203 may be configured to be capable of supplying narrowband light and/or excitation light corresponding to such special light observation.

By applying the image processing device of each of the above-described embodiments to the endoscopic surgery system, the endoscopic surgery system of the present embodiment can display a good composite image.

### Modified Embodiment

The present disclosure is not limited to the above embodiment, and various modifications are possible. For example, an example in which a part of the configuration of any of the embodiments is added to another embodiment or an example in which a part of the configuration of another embodiment is replaced with another embodiment is also an embodiment of the present disclosure.

The image processing device 1 of the above-described embodiment may change the luminance of a part or the entire image and adjust the apparent brightness before or after the composition of the right composite image 503a and the left composite image 503b.

In the image processing device 1 according to the embodiment, the imaging unit 30 may include three or more imaging units. In this case, the number of composite images and the number of images used for composition may be increased, and similar processing can be performed by the method described above.

Further, the image captured by the image processing device 1 of the above embodiment and the composite image may be applied to applications such as monitoring, and object recognition and object detection may be performed. For example, the object recognition may be performed on the composite image as an image close to the human visual field. In addition, in order to perform object detection with light processing using a low-resolution image, object detection may be performed on the center image 501c before composition.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for implementing the present disclosure, and the technical scope of the present disclosure should not be interpreted in a limited manner by these embodiments. That is, the present disclosure can be implemented in various forms without departing from the technical idea or the main feature thereof.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-228887, filed Dec. 25, 2024, which is hereby incorporated by reference herein in its entirety.

What is claimed is:

1. An image processing device comprising:
a pair of first imaging units, each configured to output a first image;
a second imaging unit configured to have a wider angle of view than an angle of view of the first imaging unit and output a second image having a resolution lower than a resolution of the first image;
a ranging unit configured to acquire a distance information based on a distance to a subject; and
a combining unit configured to generate a pair of composite images by combining each of the pair of first images with the second image based on the distance information.

2. The image processing device according to claim 1,
wherein the second imaging unit includes an imaging element capable of detecting an image plane phase difference, and
wherein the ranging unit acquires the distance information based on the image plane phase difference.

3. The image processing device according to claim 1, wherein the second imaging unit is one of a plurality of second imaging units, the image processing device comprising the plurality of the second imaging units,
wherein the ranging unit acquires the distance information by performing triangulation using a plurality of the second images output from the plurality of second imaging units.

4. The image processing device according to claim 1,
wherein optical axes of the first imaging unit and the second imaging unit are oriented in a same direction, and
wherein optical systems of the first imaging unit and the second imaging unit are provided on a same straight line.

5. The image processing device according to claim 1, further comprising a ranging device configured to measure a distance to the subject,
wherein the ranging unit acquires the distance information from the ranging device.

6. The image processing device according to claim 5,
wherein optical axes of the first imaging unit, the second imaging unit and the ranging device are oriented in a same direction, and
wherein the first imaging unit, the second imaging unit and the ranging device are provided on a same straight line.

7. The image processing device according to claim 1, wherein the combining unit converts coordinates of the second image into a coordinate system of the first image to generate a converted image.

8. The image processing device according to claim 7, wherein the combining unit converts the coordinates of the second image into the coordinate system of the first image according to the following Expression (1), and
$$M c = [ R ] [ t ] Mw \qquad ( 1 )$$
wherein in the Expression (1), Mc is the coordinate system of the first image, Mw is the coordinates of the second image, and [R] [t] is an external parameter of the first imaging unit.

9. The image processing device according to claim 8, wherein the combining unit generates the converted image from the coordinate system of the first image according to the following Expressions (2) and (3),
$$sx = AMc \qquad ( 2 )$$
$$xi = f \frac{X c}{Z c} , y i = f \frac{Y c}{Z c} \qquad ( 3 )$$
wherein in the Expression (2), s is a constant, x is coordinates of the converted image, A is an internal parameter of the first imaging unit, and Mc is the coordinate system of the first image, and
wherein in the Expression (3), xi and yi are coordinates of the converted image, respectively, f is a focal length of the first imaging unit, and, Xc, Yc, and Zc are coordinates of the coordinate system of the first image, respectively.

10. The image processing device according to claim 7, wherein the shorter the distance to the subject, the greater an amount of movement of the subject in a conversion from the second image to the converted image.

11. The image processing device according to claim 1, further comprising an image processing unit configured to transform the first image or the second image so that a shape and a size of the subject in the first image respectively correspond to a shape and a size of the subject in the second image in the composite image.

12. The image processing device according to claim 1, further comprising a pair of display units configured to display the pair of composite images respectively.

13. The image processing device according to claim 1, wherein angles of view of the first imaging unit and the second imaging unit are variable.

14. An image processing method comprising:
outputting a pair of first images;
outputting a second image having a wider angle of view than an angle of view of the pair of first images and a resolution lower than a resolution of the pair of first images;
acquiring a distance information based on a distance to a subject; and
generating a pair of composite images by combining each of the pair of first images with the second image based on the distance information.

15. A non-transitory computer-readable storage medium storing a program for causing a computer to execute a method comprising:
outputting a pair of first images;
outputting a second image having a wider angle of view than an angle of view of the pair of first images and a resolution lower than a resolution of the pair of first images;
acquiring a distance information based on a distance to a subject; and
generating a pair of composite images by combining each of the pair of first images with the second image based on the distance information.

16. A moving body comprising:
the image processing device according to claim 1; and
a control unit configured to control the moving body based on the distance information.

17. An optical detection system comprising:
the image processing device according to claim 1; and
a signal processing unit configured to process a signal output from the image processing device.
